(19) United States
(12) Patent Application Publication
(10) Pub. No.: US 2025/0392983 A1
(43) Pub. Date: Dec. 25, 2025

(54) NON-ACCESS STRATUM (NAS) SIGNALING OPTIMIZATION

(71) Applicant: Apple Inc., Cupertino, CA (US)

(72) Inventors: Piush KUMAR, Bangalore (IN); Anikethan Ramakrishna VIJAYA KUMAR, Mysuru (IN); Nitin KUPPELUR, Bangalore (IN); Deepak DASH, Bangalore (IN)

(21) Appl. No.: 19/227,173

(22) Filed: Jun. 3, 2025

Related U.S. Application Data
(60) Provisional application No. 63/663,813, filed on Jun. 25, 2024.

(51) Int. Cl. H04W 48/16; H04W 76/27; H04W 76/30

(52) U.S. Cl. CPC H04W 48/16; H04W 76/27; H04W 76/30

(57) ABSTRACT

This application regards optimization of non-access stratum signaling between a wireless device and a cellular wireless network to reduce network signaling load, conserve local access radio resources, and enhance the user experience of the wireless device. The wireless device proactively releases a packet data network (PDN) connection locally at the wireless device and marks a corresponding radio bearer inactive in a tracking area update request sent to the cellular wireless network to shorten time to complete the PDN connection, reducing network signaling load and freeing up access network resources. The wireless device also proactively releases a NAS signaling connection locally without waiting for a cellular wireless network disconnection when the NAS signaling connection is no longer required by the active subscriber identity module (SIM) of the wireless device, thereby allowing resources to be reallocated if needed to another SIM of the wireless device.

### CROSS-REFERENCE TO RELATED APPLICATIONS

The present application claims the benefit of U.S. Provisional Application No. 63/663,813, entitled “NON-ACCESS STRATUM (NAS) SIGNALING OPTIMIZATION,” filed Jun. 25, 2024, the content of which is incorporated by reference herein in its entirety for all purposes.

### FIELD

The described embodiments relate to wireless communications, including system, methods, and apparatus for optimization of non-access stratum (NAS) signaling between a wireless device and a cellular wireless network to reduce network signaling load, conserve local access radio resources, and enhance the user experience of the wireless device.

### BACKGROUND

Newer generation, fifth generation (5G), cellular wireless networks that implement one or more 3rd Generation Partnership Project (3GPP) standards are rapidly being developed and deployed by mobile network operators (MNOs) worldwide. In addition, sixth generation (6G) standards are in active development. The newer cellular wireless networks provide a range of packet-based services, with 5G (and 6G) technology providing increased data throughput and lower latency connections that promise enhanced mobile broadband services for 5G-capable (and 6G-capable) wireless devices. Access to cellular services provided by an MNO can require use to cellular credentials and/or secure processing provided by a secure element (SE), such as a universal integrated circuit card (UICC) or an embedded UICC (eUICC) included in the wireless device.

Wireless devices can be configured to use removable UICCs, that include at least a microprocessor and a read-only memory (ROM), where the ROM is configured to store an MNO profile, also referred to as subscriber identity module (SIM) or SIM profile, which the wireless device can use to register and interact with a cellular wireless network of an MNO to obtain access wireless services. The SIM profile hosts subscriber data, such as a digital identity and one or more cryptographic keys, to allow the wireless device to communicate with a cellular wireless network. Typically, a UICC takes the form of a small removable card, commonly referred to as a SIM card or physical SIM (pSIM) card, which can be inserted into a UICC-receiving bay of a mobile wireless device. In more recent implementations, UICCs are being embedded directly into system boards of wireless devices as eUICCs, which can provide advantages over traditional, removable UICCs. The eUICCs can include a rewritable memory that can facilitate installation, modification, and/or deletion of one or more electronic SIMs (eSIMs) on the eUICC, where the eSIMs can provide for new and/or different services and/or updates for accessing extended features provided by MNOs. An eUICC can store a number of MNO profiles—also referred to herein as eSIMs—and can eliminate the need to include UICC-receiving bays in wireless devices. The use of multiple SIMs and/or eSIMs is expected to offer flexibility for access to multiple services of multiple wireless networks.

A wireless device communicates data and control signals with a cellular wireless network via a network base station using wireless communication protocols. The control signals include messages at an access stratum (AS) lower layer, primarily regarding establishing and maintaining radio frequency (RF) connections with an access portion of the cellular wireless network, and at a non-access stratum (NAS) higher layer, primarily regarding managing connections and services with a core network portion of the cellular wireless network. NAS layer messaging includes session management (SM) to establish and maintain communication sessions and mobility management (MM) to handle location tracking and security functions. NAS layer control signaling based on existing 3GPP specifications can be optimized to reduce network signaling loads, conserve radio resources, and enhance responsiveness of a wireless device.

### SUMMARY

The described embodiments relate to wireless communications, including system, methods, and apparatus for optimization of non-access stratum (NAS) signaling between a wireless device and a cellular wireless network to reduce network signaling load, conserve local access radio resources, and enhance the user experience of the wireless device. In a first embodiment, a wireless device monitors completion of a disconnection procedure of an active packet data network (PDN) connection. When a tracking area update (TAU) procedure is initiated before the ongoing disconnection procedure of the PDN connection has completed or when a PDU session at the wireless device has an inactive pending status, the wireless device releases the PDN connection locally at the wireless device and marks the corresponding enhanced packet service (EPS) bearer status as inactive in an EPS bearer context status information element (IE) of a TAU update request message sent to the cellular wireless network as part of the TAU procedure. Proactively releasing the EPS bearer associated with the PDN connection being disconnected locally at the wireless device avoids extended time and multiple attempts by the wireless device to complete the PDN disconnect procedure and forestalls an additional TAU procedure required to update the EPS status from active to inactive to the cellular wireless network. This optimization reduces network signaling and frees up radio resources in the access portion of the cellular wireless network. In a second embodiment, a wireless device initiates a connection release timer after completion of an upper layer signaling procedure for which the wireless device established a NAS signaling connection only and moved from an idle state to a connected state. Once upper layer signaling is over, the NAS function starts a connection release timer to move the wireless device from the connected state to the idle state. Upon expiration of the connection release timer, the wireless device releases the NAS signaling connection locally at the wireless device and transitions from the connected state to the idle state. This local connection release based on a local connection release timer at the wireless device more rapidly releases access network radio resources for use by another subscriber identity module (SIM) of the wireless device or by other wireless devices, rather than waiting an indeterminate network dependent time period for the cellular wireless network to release the NAS signaling connection. In a third embodiment, the wireless device initiates a connection release timer with a shorter than standardized time duration or skips the connection release timer altogether and immediately releases a NAS signaling connection when a cell selection or public land mobile network (PLMN) search is pending after receiving a registration reject message from a cellular wireless network. Reducing the time to release the NAS signaling connection allows the wireless device to proceed with the cell selection or PLMN search more immediately, which reduces time to locate and attach to a suitable cellular wireless network. In a fourth embodiment, when a security capability of a wireless device changes while in a registered state with a fifth generation (5G) stand-alone (SA) cellular wireless network, the wireless device triggers a mobility registration procedure to update the cellular wireless network with the changed security capability of the wireless device. The wireless device proactively updates its security capability with the cellular wireless network to forestall a security capability mismatch that can cause unexpected behavior in communication between the wireless device and the cellular wireless network.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1A illustrates a diagram of an exemplary network architecture for communication between a wireless device and a cellular wireless network, according to some embodiments.

FIG. 1B illustrates a diagram of an exemplary software protocol stack for communication of signaling messages between a wireless device and a cellular wireless network, according to some embodiments.

FIGS. 2A and 2B illustrate diagrams of an exemplary improvement for non-access stratum (NAS) signaling when deactivating a packet data network (PDN) connection under adverse network conditions, according to some embodiments.

FIGS. 3A and 3B illustrate diagrams of an exemplary improvement for NAS connection release by a wireless device, according to some embodiments.

FIGS. 4A and 4B illustrate diagrams of an exemplary improvement for recovering normal service by a wireless device after rejection by a cellular wireless network, according to some embodiments.

FIGS. 5A and 5B illustrate diagrams of an exemplary improvement for updating wireless security capabilities with a cellular wireless network, according to some embodiments.

FIGS. 6A, 6B, and 6C illustrate flowcharts of exemplary methods performed by a wireless device to improve NAS signaling with a cellular wireless network, according to some embodiments.

FIG. 7 illustrates a block diagram of exemplary elements of a wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

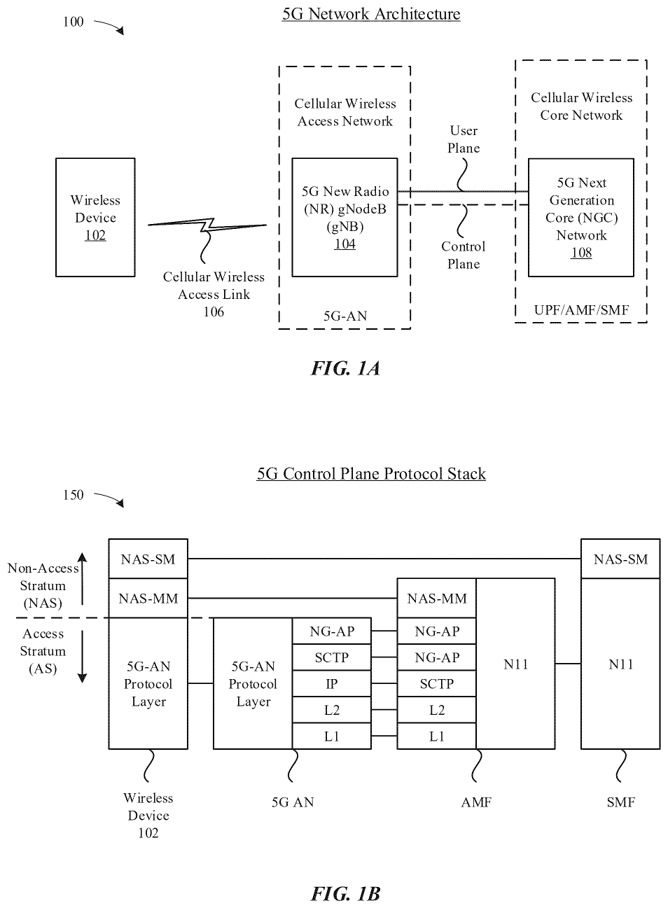

The embodiments are discussed below with reference to FIGS. 1 through 7; however, those skilled in the art will readily appreciate that the detailed description given herein with respect to these figures is for explanatory purposes only and should not be construed as limiting.

FIG. 1A illustrates a diagram 100 of an exemplary network architecture of a fifth generation (5G) cellular wireless network. A wireless device 102 communicates with a 5G new radio (NR) gNodeB (gNB) 104 in an access network (AN) portion of the 5G cellular wireless network via a cellular wireless access link 106. The 5G NR gNB 104 manages radio frequency (RF) resources among multiple wireless devices 102 and establishes, maintains, and terminates radio bearers that communicate user data and control signaling between the wireless device 102 and the cellular wireless network. The 5G NR gNB 104 connects to a 5G next generation core (NGC) network 108 that provides multiple functions for management of communication services for wireless devices 102, with user data communicated via the user plane connection and control signaling communicated via the control plane connection. Exemplary functions provided by the 5G NGC include: i) a user plane function (UPF) for handling data packets, ii) an access and mobility management function (AMF) for handling registration of a wireless device, security and authentication, and non-access stratum (NAS) signaling, and iii) a session management function (SMF) for establishment and release of packet data unit (PDU) sessions between the wireless device 102 and the cellular wireless network.

FIG. 1B illustrates a diagram 150 of an exemplary control plane software protocol stack for a wireless device 102 connected to a 5G cellular wireless network. A 5G-AN software protocol layer in the wireless device 102 communicates access stratum (AS) level messages with a corresponding 5G-AN software protocol layer in the 5G-AN portion of the 5G cellular wireless network. The AS layer terminates at the 5G NR gNB 104 of the 5G-AN, which connects via additional parallel layers to the AMF portion of the 5G NGC network 108. A NAS mobility management (MM) software protocol layer of the NAS layer at the wireless device 102 connects to a corresponding NAS-MM software protocol layer of the AMF in the 5G NGC network 108, where NAS layer signaling at the NAS-MM layer handles location tracking and security functions. Similarly a NAS session management (SM) software protocol layer of the NAS layer at the wireless device 102 connects to a corresponding NAS-SM software protocol layer of the SMF in the 5G NGC network 108, where NAS layer signaling at the NAS-SM layer manages establishing and maintenance of communication sessions between the wireless device 102 and the cellular wireless network. Published 3GPP cellular wireless communication standards describe mandatory and optional procedures for a wireless device 102 to communicate NAS layer signaling with a cellular wireless network. In some circumstances, procedures for NAS layer signaling by the wireless device 102 can be improved to allow the wireless device 102 to recover from error conditions or to make resources of the cellular wireless network (or of the wireless device 102) available more readily, as discussed further herein.

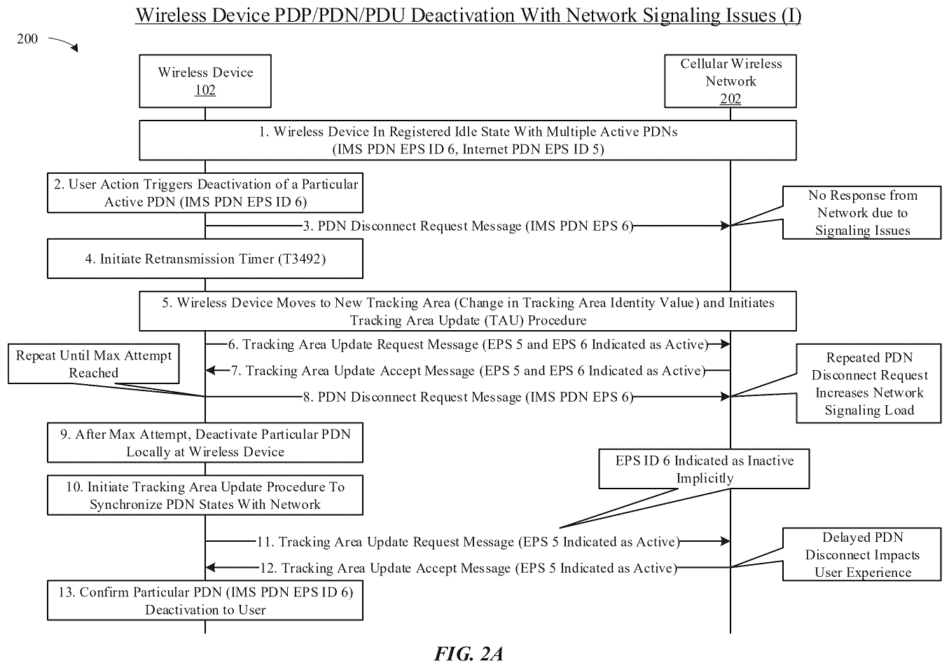

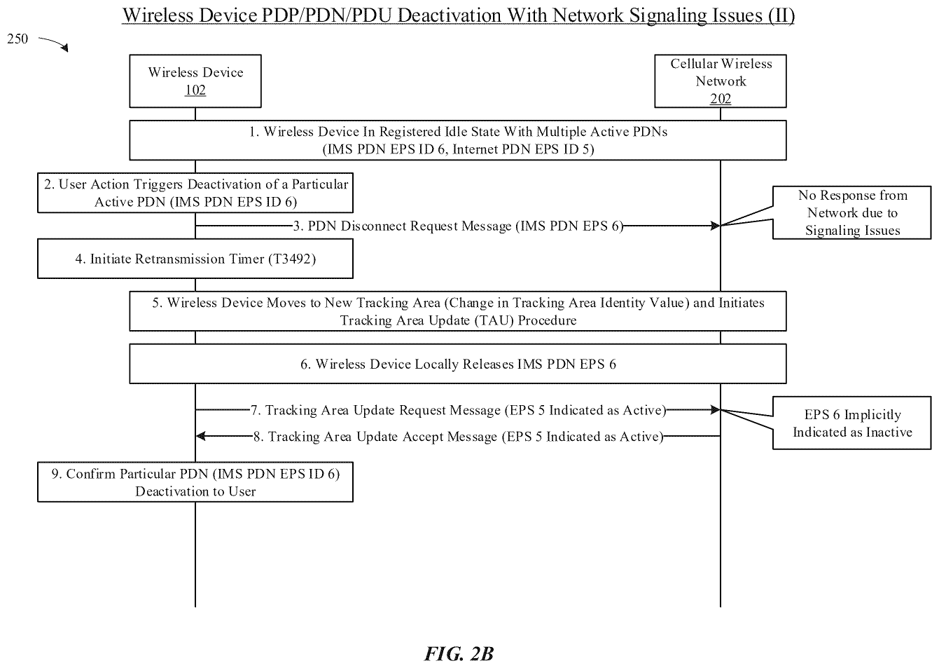

FIG. 2A illustrates a diagram 200 of an exemplary NAS signaling message exchange for deactivation of a packet data protocol (PDP) context and/or packet data network (PDN) connection for packet data unit (PDU) communication during poor network performance conditions that interfere with the wireless device 102 obtaining from the cellular wireless network 202 one or more responses to requests sent to the cellular wireless network 202. For representative purposes, the following example describes an interworking between a wireless device and a 3GPP fourth generation (4G) long term evolution (LTE) system with a tracking area update (TAU) procedure. The scope of this disclosure is not limited to a 4G LTE with TAU procedure only and can be extended to other radio access technologies (RATs) and additional applicable procedures. Although the following actions are described in the context of steps (e.g., step one, step two, etc.), this does not limit the order in which such steps may be completed. At step one, the wireless device 102 can be registered with the cellular wireless network 202 in an idle state with multiple active PDN connections, e.g., a first PDN connection designated for use with an Internet Protocol Multimedia Subsystem (IMS) service and associated with an enhanced packet service (EPS) radio bearer having the identifier (ID) value 6, and a second PDN connection designated for use with a data Internet service and associated with an EPS radio bearer having the ID value 5. At step two, a user action at the wireless device 102 triggers deactivation of one of the active PDNs, e.g., the IMS PDN with EPS ID value 6. At step three, the wireless device 102 sends to the cellular wireless network 202 a PDN disconnect request message including an indication of the active PDN to be deactivated, e.g., IMS PDN EPS ID 6. Due to temporary poor signaling performance, the cellular wireless network may not provide a response to the PDN disconnect request message, and the wireless device, at step four, initiates a retransmission timer, e.g., a T3492 timer. A duration value of the retransmission timer may depend on a particular radio access technology (RAT) with which the wireless device 102 is registered with the cellular wireless network 202. Before expiration of the retransmission timer, at step five, the wireless device 102 moves to a new tracking arca, e.g., a tracking arca identity (TAI) value received from the cellular wireless network 202 changes indicating that the wireless device 102 is in a new tracking area with respect to an existing registered tracking area list, and the wireless device 102 initiates a tracking area update (TAU) procedure. At step six, the wireless device 102 sends to the cellular wireless network 202 a TAU update request message that includes indications of the multiple active PDN connections, e.g., the IMS PDN connection with EPS ID value 6 and the Internet PDN connection with EPS ID value 5 are both indicated as active. In particular, the IMS PDN connection with EPS ID value 6, for which the wireless device 102 previously sent to the cellular wireless network 202 a request to disconnect, remains active as the cellular wireless network 202 has not confirmed the disconnection request of the IMS PDN connection with EPS ID value 6 to the wireless device 102. At step seven, the cellular wireless network 202 responds to the TAU request message from the wireless device 102 with a TAU accept message that confirms the status of the multiple active PDN connections, e.g., the IMS PDN connection with EPS ID value 6 and the Internet PDN connection with EPS ID value 5 are both indicated as active. At step eight, after expiration of the retransmission timer previously set at step 4, the wireless device 102 resends to the cellular wireless network 202 a PDN disconnect request message identifying the IMS PDN connection with EPS ID value 6. In some circumstances where poor network performance and signaling issues persists, the cellular wireless network 202 may again not respond to the request to disconnect the IMS PDN connection with EPS ID value 6, and the wireless device 102 may repeatedly send disconnect requests (after expiration of associated retransmission timers), which increases the signaling load in the access portion of the cellular wireless network and delays completion of the PDN disconnection for the wireless device 102. After a maximum number of retransmissions of the PDN disconnect request message are sent to the cellular wireless network 202, the wireless device 102, at step nine, deactivates the active PDN connection locally at the wireless device 102. At step ten, in accordance with 3GPP standardized procedures, the wireless device 102 initiates another TAU procedure to synchronize the state of the locally deactivated PDN connection with EPS ID value 6 with the cellular wireless network 202. At step eleven, the wireless device 102 sends a second TAU request message to the cellular wireless network 202 that indicates only the active PDN connections, where the inactive PDN connection, e.g., the IMS PDN connection with EPS ID value 6, is not indicated as active, and therefore is indicated implicitly to the cellular wireless network 202 as inactive. In some embodiments, only active PDN connections are indicated in the TAU request messages send by the wireless device 102 to the cellular wireless network 202. At step twelve, the cellular wireless network 202 responds to the second TAU request message with a TAU accept message that confirms the active PDN connections, and implicitly confirms that the IMS PDN connection with EPS ID value 6 is recognized as inactive by the cellular wireless network 202. At step thirteen, the wireless device 102 confirms to the user that the particular PDN (IMS PDN with EPS ID value 6) has been deactivated. The signaling sequence illustrated in FIG. 2A with two separate TAU procedures and multiple requests to disconnect the PDN connection delays completion of the PDN disconnection which was requested by the user, thereby impacting the user experience. In addition multiple disconnect attempts and multiple TAU procedures adds to the signaling load in the access portion and the core portion of the cellular wireless network 202.

FIG. 2B illustrates a diagram 250 of an exemplary NAS signaling message exchange for deactivation of a PDP context and/or PDN connection for PDU communication under poor network performance conditions with improvements to reduce excess network signaling and shorten completion of the requested deactivation compared with the sequence illustrated in FIG. 2A. For representative purposes, the following example describes an interworking between a wireless device and a 3GPP fourth generation (4G) long term evolution (LTE) system with a tracking arca update (TAU) procedure. The scope of this disclosure is not limited to a 4G LTE with TAU procedure only and can be extended to other radio access technologies (RATs) and additional applicable procedures. Although the following actions are described in the context of steps (e.g., step one, step two, etc.), this does not limit the order in which such steps may be completed. Initially, at step one, the wireless device 102 can be registered with the cellular wireless network 202 in an idle state with multiple active PDN connections, e.g., a first PDN connection designated for use with an Internet Protocol Multimedia Subsystem (IMS) service and associated with an enhanced packet service (EPS) radio bearer having the identifier (ID) value 6, and a second PDN connection designated for use with a data Internet service and associated with an EPS radio bearer having the ID value 5. At step two, a user action at the wireless device 102 triggers deactivation of one of the active PDNs, e.g., the IMS PDN with EPS ID value 6. At step three, the wireless device 102 sends to the cellular wireless network 202 a PDN disconnect request message including an indication of the active PDN to be deactivated, e.g., IMS PDN EPS ID 6. Due to temporary poor signaling performance, the cellular wireless network may not provide a response to the PDN disconnect request message, and the wireless device, at step four, initiates a retransmission timer, e.g., a T3492 timer. A duration value of the retransmission timer may depend on a particular radio access technology (RAT) with which the wireless device 102 is registered with the cellular wireless network 202. Before expiration of the retransmission timer, at step five, the wireless device 102 initiates a tracking area update (TAU) procedure as a result of a trigger, e.g., the wireless device 102 moves to a new tracking area where a tracking area identity (TAI) value received from the cellular wireless network 202 changes indicating that the wireless device 102 is in a new tracking area with respect to an existing registered tracking area list. When the wireless device 102 initiates a TAU procedure, if there are any active PDN connections for which there is a pending PDN disconnection request or if a PDU session status is indicated as “PDU Session Inactive Pending” at the wireless device 102, the wireless device 102, at step six, can release the PDN connection locally at the wireless device 102 and mark the EPS bearer corresponding to the released PDN connection, e.g., EPS ID 6 associated with the IMS PDN, as “inactive” in an EPS bearer context status information element (IE) of a subsequent TAU request message. At step seven, the wireless device 102 sends to the cellular wireless network 202 a TAU update request message that includes indications of the active PDN connections, e.g., the Internet PDN connection with EPS ID value 5 is indicated as active, while the IMS PDN connection with EPS ID value 6 is indicated as inactive, either implicitly (by not being indicated as active in the TAU request message) in some embodiments or explicitly (by including an inactive indication in the TAU request message) in some embodiments (not shown). In some embodiments, only active PDN connections are indicated in the TAU request messages send by the wireless device 102 to the cellular wireless network 202. By marking the EPS bearer with ID value 5 as inactive in the EPS bearer context status IE of the TAU request message, the wireless device 102 avoids performing an additional TAU procedure as in FIG. 2A. In addition, the indication of the inactive status in the TAU request message (and subsequent acceptance by the cellular wireless network 202) completes the PDN disconnection procedure initiated at step two, which would otherwise take a longer time to complete, potentially with multiple attempts to communicate the PDN disconnect message as in FIG. 2A. At step eight, the cellular wireless network 202 responds to the TAU request message with a TAU accept message that confirms the active PDN connections, and implicitly confirms that the IMS PDN connection with EPS ID value 6 is recognized as inactive by the cellular wireless network 202. At step nine, the wireless device 102 confirms to the user that the particular PDN (IMS PDN with EPS ID value 6) has been deactivated. The sequence illustrated in FIG. 2B can be applied to various 3GPP RATs including 4G Long Term Evolution (LTE) and 5G New Radio (NR) and to various other procedures where the wireless device 102 can use NAS layer mobility management (MM) messages to indicate an active packet data protocol (PDP)/packet data network (PDN)/packet data unit (PDU) status to the cellular wireless network 202.

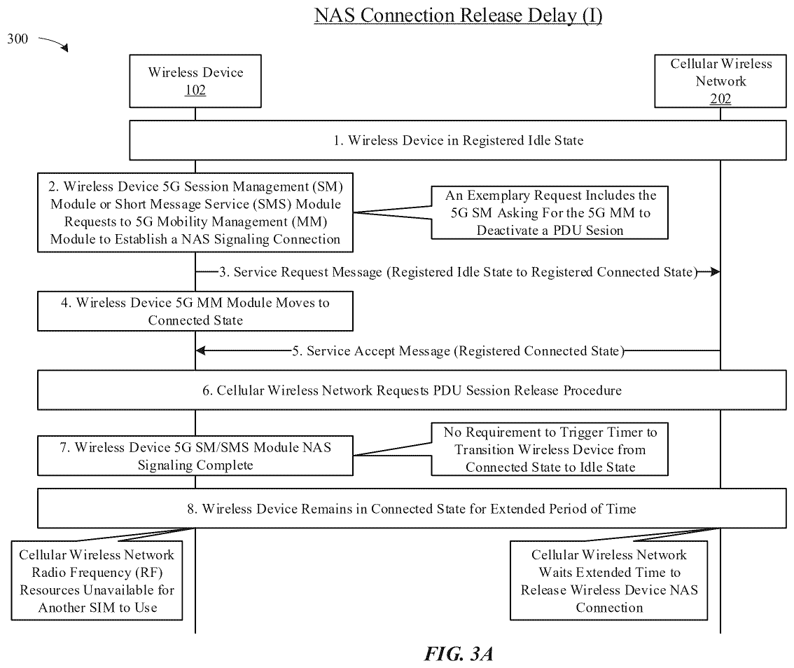

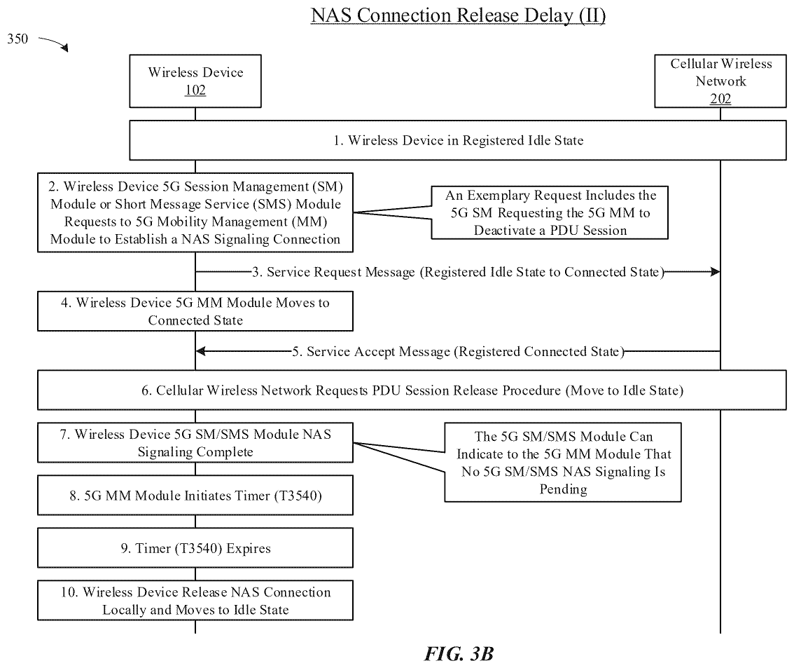

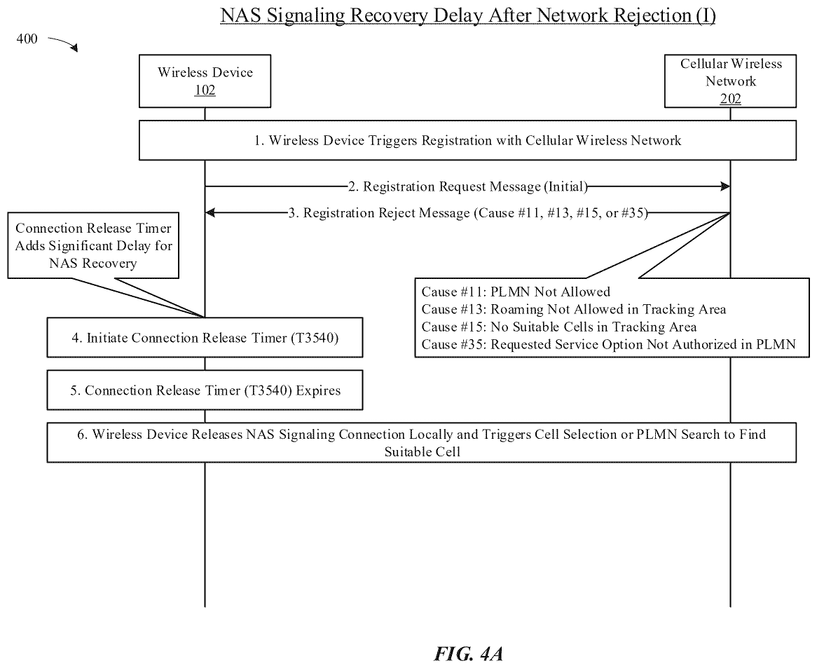

FIG. 3A illustrates a diagram 300 of an exemplary NAS signaling message exchange that can result in an extended time to release a NAS connection between a wireless device 102 and a cellular wireless network 202. Although the following actions are described in the context of steps (e.g., step one, step two, etc.), this does not limit the order in which such steps may be completed. At step one, the wireless device 102 is registered with the cellular wireless network 202 in an idle state. In some embodiments, the wireless device 102 can have multiple active PDN connections while in an idle mode. At step two, a 5G session management (SM) module or a short message service (SMS) module of the wireless device 102 requests to a 5G mobility management (MM) module of the wireless device 102 to establish a NAS signaling connection only with the cellular wireless network 202. An exemplary request can include the 5G SM module of the wireless device 102 requesting the 5G MM module of the wireless device 102 to deactivate a PDU session, which can require an active NAS signaling connection with the cellular wireless network 202 to perform a PDU session release procedure. Another exemplary request can include the 5G short message service (SMS) module of the wireless device 102 requesting the 5G MM module of the wireless device 102 to transmit an SMS message to the cellular wireless network 202, which can also require an active NAS signaling connection with the cellular wireless network 202 to perform the SMS messaging procedure. At step three, the wireless device 102 sends to the cellular wireless network 202 a service request message to change from the registered idle state to a registered connected state. At step four, the 5G MM module of the wireless device 102 moves to the registered connected state. At step five, the wireless device 102 receives from the cellular wireless network 202 a service accept message that confirms the cellular wireless network 202 recognizes that the wireless device 102 is in the registered connected state. At step six, the wireless device 102 and the cellular wireless network 202 perform a PDU session release procedure, which can be requested by the cellular wireless network 202. At step seven, the NAS signaling connection, which was established responsive to the request from the 5G SM module or the 5G SMS module, is no longer required by the 5G SM or SMS modules. In some embodiments, the 5G SM or SMS modules provide an indication to the 5G MM module that the NAS signaling for an SM service or for an SMS service is no longer required, e.g., that there are no pending NAS signaling required by the SM module or the SMS module. The 3GPP standards protocols do not require the wireless device 102 to trigger a connection release timer to transition from the connected state to an idle state, including when there are no active data radio bearers (DRBs) established. The cellular wireless network 202 may not release the NAS signaling connection for an extended period of time, which can result in an unintended extended use of cellular wireless resources, depriving other SIM instances in the wireless device 102 of access to critical RF resources. As a result, at step eight, the wireless device 102 can remain in the connected state (rather than the idle state) for an extended period of time before being released by the cellular wireless network 202. Different cellular wireless networks 202 have different timers for inactive NAS signaling connections, which can result in variable behavior for the wireless device 102.

FIG. 3B illustrates a diagram 350 of an exemplary NAS signaling message exchange including improvements to foreshorten time to release a NAS signaling connection between a wireless device 102 and a cellular wireless network 202 when the NAS signaling connection is no longer required by the wireless device 102. Although the following actions are described in the context of steps (e.g., step one, step two, etc.), this does not limit the order in which such steps may be completed. At step one, the wireless device 102 is registered with the cellular wireless network 202 in an idle state. In some embodiments, the wireless device 102 can have multiple active PDN connections while in an idle mode. At step one, the wireless device 102 is registered with the cellular wireless network 202 in an idle state. In some embodiments, the wireless device 102 can have multiple active PDN connections while in an idle mode. At step two, a 5G session management (SM) module or a short message service (SMS) module of the wireless device 102 requests to a 5G mobility management (MM) module of the wireless device 102 to establish a NAS signaling connection only with the cellular wireless network 202. An exemplary request can include the 5G SM module of the wireless device 102 requesting the 5G MM module of the wireless device 102 to deactivate a PDU session, which can require an active NAS signaling connection with the cellular wireless network 202 to perform a PDU session release procedure. Another exemplary request can include the 5G short message service (SMS) module of the wireless device 102 requesting the 5G MM module of the wireless device 102 to transmit an SMS message to the cellular wireless network 202, which can also require an active NAS signaling connection with the cellular wireless network 202 to perform the SMS messaging procedure. At step three, the wireless device 102 sends to the cellular wireless network 202 a service request message to change from the registered idle state to a registered connected state. At step four, the 5G MM module of the wireless device 102 moves to the registered connected state. At step five, the wireless device 102 receives from the cellular wireless network 202 a service accept message that confirms the cellular wireless network 202 recognizes that the wireless device 102 is in the registered connected state. At step six, the wireless device 102 and the cellular wireless network 202 perform a PDU session release procedure, which can be requested by the cellular wireless network 202. Alternatively at step six (not shown), the wireless device 102 and the cellular wireless network 202 can successfully complete transmission of SMS data. At step seven, the NAS signaling connection, which was established responsive to the request from the 5G SM module or the 5G SMS module, is no longer required by the 5G SM or SMS modules. In some embodiments, the 5G SM or SMS modules provide an indication to the 5G MM module that the NAS signaling for an SM service or for an SMS service is no longer required, e.g., that there are no pending NAS signaling required by the SM module or the SMS module. Although the 3GPP standards protocols do not require the wireless device 102 to trigger a connection release timer to transition from the connected state to an idle state, at step eight, the 5G MM module of the wireless device 102 initiates a connection release timer, e.g., a T3540 timer. In some embodiments, a duration value of the connection release timer, e.g., the T3540 timer, can be set to a small non-zero value (or in some embodiments a zero value), and the wireless device 102 initiates a connection release at expiration of the connection release timer, for a non-zero value, or substantially immediately, for a zero value. At step nine, the connection release timer expires, and at step ten, the wireless device 102 releases the NAS signaling connection at the wireless device 102 and moves from the connected state to the idle state. With release of the NAS signaling connection, the wireless device 102 can reallocate internal resources and/or the cellular wireless network 202 can reallocate access network resources that would otherwise be unnecessarily allocated without a pending requirement to be used. The sequence illustrated in FIG. 3B can be applied to various 3GPP RATs including 4G LTE and 5G NR.

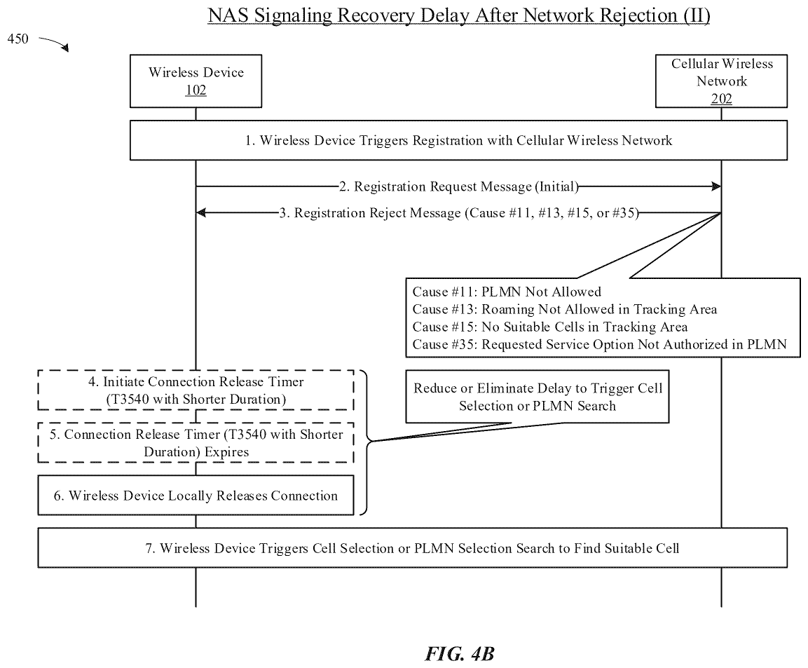

FIG. 4A illustrates a diagram 400 of an exemplary NAS signaling message exchange in which a cell selection procedure or a PLMN search procedure to be performed by a wireless device 102 with a cellular wireless network 202 is delayed due to the length of a connection release timer at the wireless device 102 as per current 3GPP standards. Although the following actions are described in the context of steps (e.g., step one, step two, etc.), this does not limit the order in which such steps may be completed. At step one, the wireless device 102 triggers a registration procedure with the cellular wireless network 202. At step two, the wireless device 102 sends a registration request message to the cellular wireless network 202. At step three, the cellular wireless network 202 responds to the registration request message of the wireless device 102 with a registration reject message that includes one of the following causes for rejection: i) cause #11,which indicates the PLMN is not allowed, ii) cause #13, which indicates that roaming is not allowed in the tracking area, iii) cause #15, which indicates that no suitable cells are available in the tracking area, or iv) cause #35, which indicates that the requested service option is not authorized in the PLMN. In accordance with current NAS signaling procedures of 3GPP standards protocols, the wireless device 102 is required to start a connection release timer, e.g., a T3540 timer, when the wireless device 102 transitions to any of the following states: “deregistered-limited service”, “deregistered-PLMN-search”, “registered-limited-service, or “registered-PLMN-search” responsive to a network reject message that includes one of the above listed causes for rejection. In order to handle the network rejection, the wireless device 102 is required to initiate a cell selection process and/or a PLMN search process; however, these processes can only be triggered after the wireless device 102 releases the active NAS signaling connection via which the registration request message was sent and the registration reject message was received. At step four, the wireless device 102 initiates a connection release timer, e.g., a T3540 timer, which adds significant delay to recover from the network rejection. At step five, the connection release timer, e.g., the T3540 timer, expires, and at step six, the wireless device 102 release the NAS signaling connection locally at the wireless device 102 and triggers a cell selection procedure or a PLMN search process to find a suitable cell on which to camp the wireless device 102. Alternatively, in some embodiments, while the connection release timer has not yet expired at the wireless device 102, the cellular wireless network 202 can release the connection to the wireless device 102, and the wireless device 102 can initiate recovery as indicated at step six. The connection release timer can add multiple seconds to NAS recovery following the network rejection and can stall the wireless device 102 from attaching to another suitable cellular wireless network 202, during which time a user of the wireless device 102 can be unable to access cellular wireless network services.

FIG. 4B illustrates a diagram 450 of an exemplary NAS signaling message exchange that can shorten the time to release a NAS connection and allow a wireless device 102 to perform a cell selection process and/or a PLMN search procedure. Although the following actions are described in the context of steps (e.g., step one, step two, etc.), this does not limit the order in which such steps may be completed. At step one, the wireless device 102 triggers a registration procedure with the cellular wireless network 202. At step two, the wireless device 102 sends a registration request message to the cellular wireless network 202. At step three, the cellular wireless network 202 responds to the registration request message of the wireless device 102 with a registration reject message that includes one of the following causes for rejection: i) cause #11,which indicates the PLMN is not allowed, ii) cause #13, which indicates that roaming is not allowed in the tracking area, iii) cause #15, which indicates that no suitable cells are available in the tracking area, or iv) cause #35, which indicates that the requested service option is not authorized in the PLMN. In some embodiments, the wireless device 102 proceeds directly to step six and locally releases the NAS signaling connection locally at the wireless device 102 to eliminate delay in triggering a cell selection process and/or a PLMN search procedure performed at step seven. In some embodiments, the wireless device 102, at step four, initiates a connection release timer, e.g., a T3540 timer, with a shorter duration, e.g., one second instead on the usual ten seconds, or as low as zero seconds (effectively an immediate release timer). At step five, the shorter duration (or zero duration) connection release timer expires, allowing the wireless device 102 to proceed with releasing the NAS signaling connection locally at the wireless device 102 at step six and proceed with triggering the cell selection process and/or the PLMN search procedure to find a suitable cell for the wireless device 102 at step seven. The shorter duration connection release timer can reduce the delay incurred to trigger the cell selection process and/or the PLMN search procedure. The wireless device 102 can more quickly respond and recover from the network rejection with this shortened (or eliminated) connection release timer. The sequence illustrated in FIG. 4B can be applied to various 3GPP RATs including 4G LTE and 5G NR.

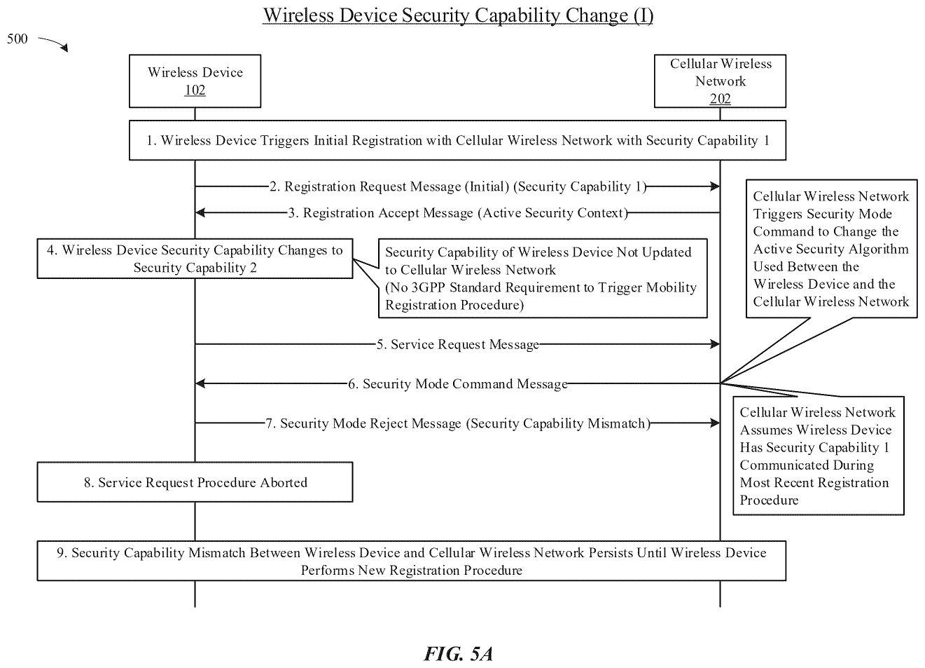

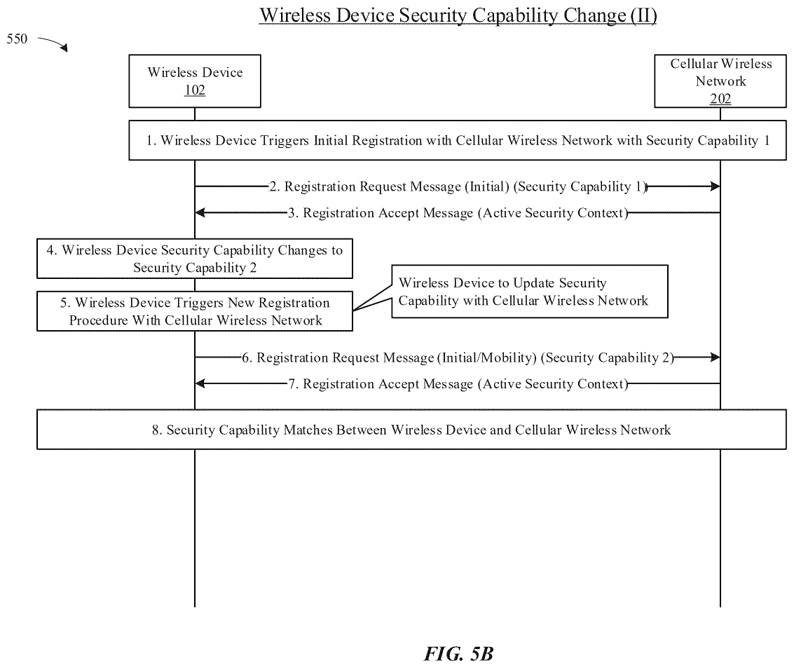

FIG. 5A illustrates a diagram 500 of an exemplary NAS signaling message sequence exchange in which a security capability change at a wireless device 102 can cause a mismatch with a previous security capability established by the wireless device 102 with a 5G stand-alone (SA) cellular wireless network 202. Although the following actions are described in the context of steps (e.g., step one, step two, etc.), this does not limit the order in which such steps may be completed. At step one, the wireless device 102 triggers an initial registration procedure with the cellular wireless network 202 with a first security capability having an identifier value of 1. At step two, the wireless device 102 sends to the cellular wireless network 202 an initial registration request message that includes an indication of the security capability of the wireless device 102, the security capability having the identifier value of 1. At step three, the cellular wireless network 202 responds to the wireless device 102 with a registration accept message that indicates an active security context for use between the wireless device 102 and the cellular wireless network 202. The active security context selected by the cellular wireless network 202 to use with the wireless device 102 can be based on the provided security capability with identifier value of 1. At step four, the security capability of the wireless device 102 is changed, e.g., updated based on firmware or configuration change, to a security capability with identifier value of 2. The updated security capability may differ from the security capability previously used and indicated to the cellular wireless network 202. Per current 3GPP cellular wireless standardized protocols, the wireless device 102 is not required to update the cellular wireless network 202 regarding the changed security capability of the wireless device 102. There is no requirement standardized by 3GPP protocols to trigger a mobility registration procedure responsive to the change in security capability of the wireless device 102. As such the security algorithms supported by the wireless device 102 with the new security capability may differ from the security algorithms previously supported with the previous security capability, which can cause a conflict with the cellular wireless network 202 and result in inconsistent or unexpected behaviors when the wireless device 102 communicates assuming certain security capabilities can be used, and the cellular wireless network 202 is unaware of the security capability change that has occurred at the wireless device 102. At step five, the wireless device 102 sends a service request message to the cellular wireless network 202. At step six, the cellular wireless network 202 responds to the service request message from the wireless device 102 with a security mode command message, where the cellular wireless network 202 can assume that the wireless device 102 continues to have the security capability with identifier value of 1 as communicated in the most recent registration process. In some embodiments, the cellular wireless network 202 triggers a security mode command with the wireless device 102 to change the active security algorithm used between the wireless device 102 and the cellular wireless network 202. The wireless device 102, which has a different security capability with identifier value of 2, may not be able to comply with the requested security mode change from the cellular wireless network 202. At step seven, the wireless device 102 responds to the cellular wireless network 202 with a security mode reject message with an indication that there is a mismatch in security capability between what the wireless device 102 can use, based on the updated security capability with identifier value of 2, and what the cellular wireless network 202 requested, based on the previous security capability with identifier value of 1. Because of the security capability mismatch, at step eight, the wireless device 102 can abort the service request procedure and continue to use the most recent security context (unable to comply with the requested change in security mode received from the cellular wireless network 202). At step nine, the security capability mismatch between the wireless device 102 and the cellular wireless network 202 can persist until the wireless device 102 performs a new registration procedure to update the cellular wireless network 202 as to its updated security capability.

FIG. 5B illustrates a diagram 550 of an exemplary NAS signaling message exchange that triggers a mobility registration procedure between a wireless device 102 and a 5G stand-alone (SA) cellular wireless network 202 responsive to a change in security capability of the wireless device 102. The mobility registration procedure can be used to update the 5G SA cellular wireless network 202 regarding the change in security capability of the wireless device 102 and avoid the mismatch in security capability understanding between the wireless device 102 and the 5G SA cellular wireless network 202 illustrated by FIG. 5A. Although the following actions are described in the context of steps (e.g., step one, step two, etc.), this does not limit the order in which such steps may be completed. At step one, the wireless device 102 triggers an initial registration procedure with the cellular wireless network 202 with a first security capability having an identifier value of 1. At step two, the wireless device 102 sends to the cellular wireless network 202 an initial registration request message that includes an indication of the security capability of the wireless device 102, the security capability having the identifier value of 1. At step three, the cellular wireless network 202 responds to the wireless device 102 with a registration accept message that indicates an active security context for use between the wireless device 102 and the cellular wireless network 202. The active security context selected by the cellular wireless network 202 to use with the wireless device 102 can be based on the provided security capability with identifier value of 1. At step four, the security capability of the wireless device 102 is changed, e.g., updated based on firmware or configuration change, to a security capability with identifier value of 2. The updated security capability may differ from the security capability previously used and indicated to the cellular wireless network 202. At step five, the wireless device 102 triggers a new registration procedure with the cellular wireless network 202 to update the cellular wireless network 202 regarding the updated security capability of the wireless device 102. At step six, the wireless device 102 sends to the cellular wireless network 202 a registration request message (which can be an initial or mobility type of registration request message), where the registration request message includes an indication of the updated security capability of the wireless device 102, the updated security capability having the identifier value of 2. At step seven, the cellular wireless network 202 responds to the wireless device 102 with a registration accept message that indicates an active security context for use between the wireless device 102 and the cellular wireless network 202. The active security context selected by the cellular wireless network 202 to use with the wireless device 102 can be based on the provided security capability with identifier value of 2. At step eight, the security capability of the wireless device 102 can match the security capability known to the cellular wireless network 202.

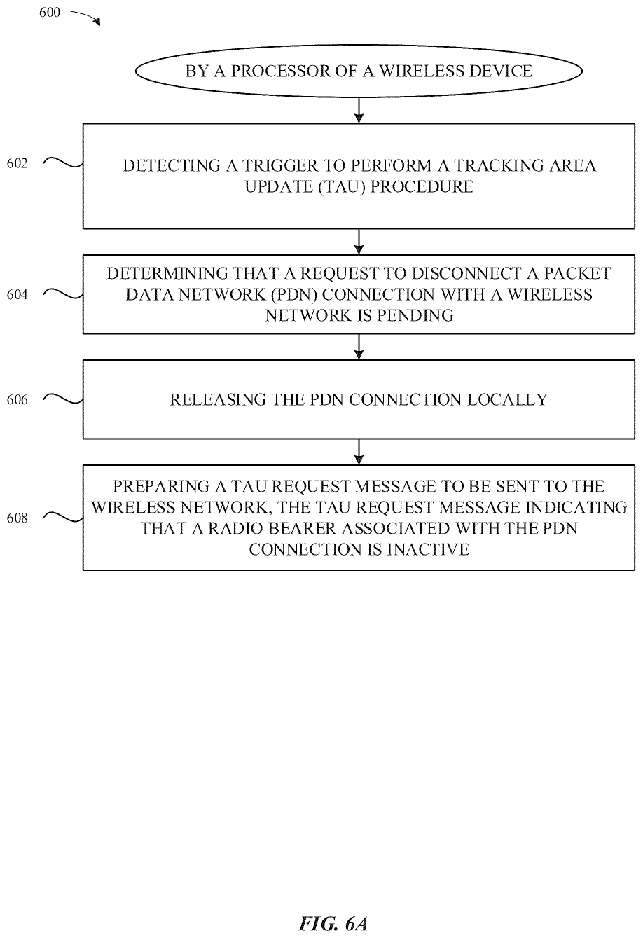

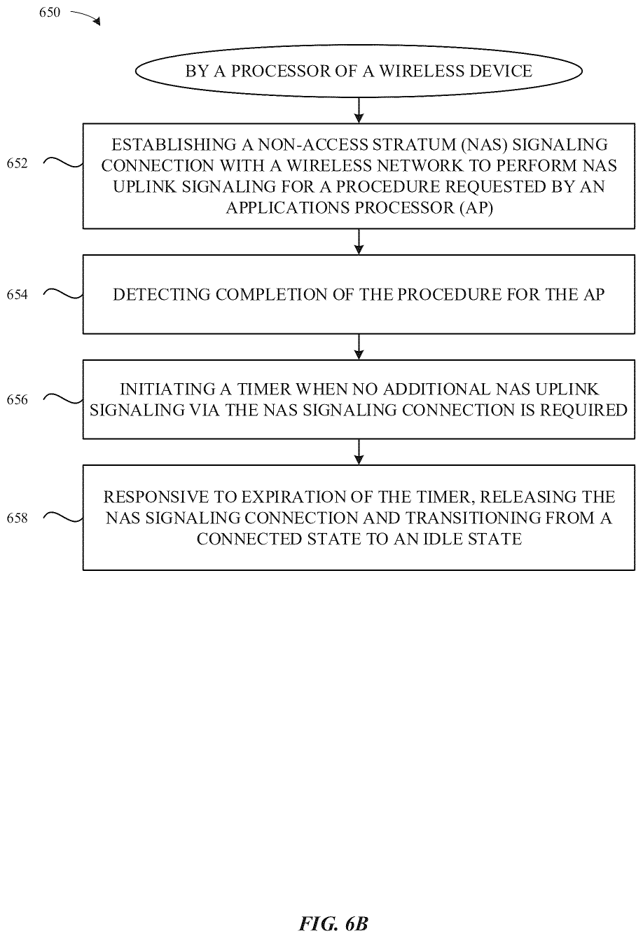

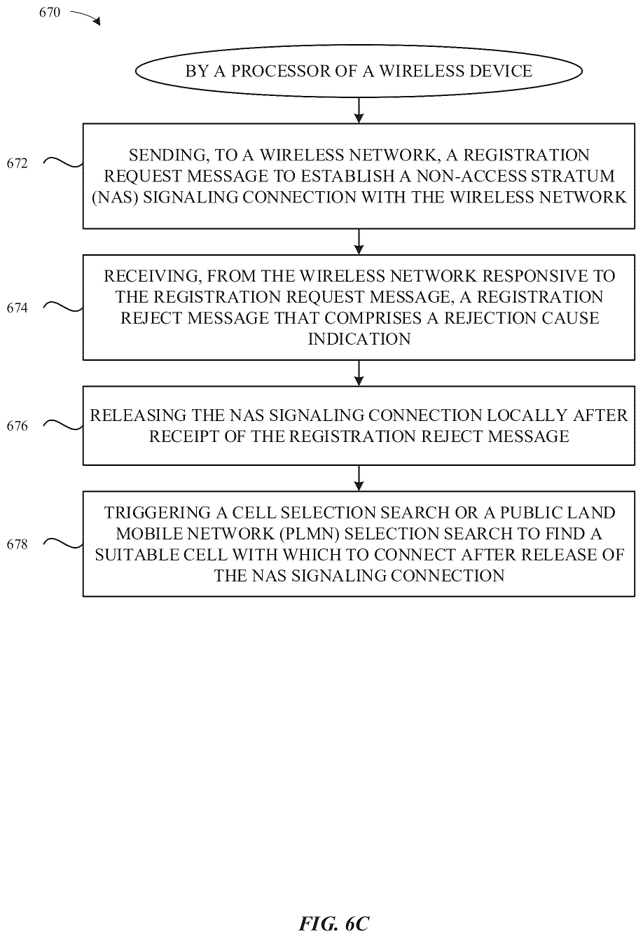

FIG. 6A illustrates a flowchart 600 of an exemplary method of NAS signaling between a processor of a wireless device 102 and a wireless network. At 602, a processor of a wireless device 102 detects a trigger to perform a tracking area update (TAU) procedure. At 604, the processor of the wireless device 102 determines that a request to disconnect a packet data network (PDN) connection with a wireless network is pending. At 606, the processor of the wireless device 102 releases the PDN connection to the wireless network locally. At 608, the processor of the wireless device 102, prepares a TAU request message to be sent to the wireless network, the TAU request message indicating a radio bearer associated with the PDN connection is inactive.

In some embodiments, the trigger to perform the TAU procedure includes a change in a tracking area identity (TAI) value of the wireless network based on a location of operation. In some embodiments, the TAU request message does not include an identifier value for the radio bearer associated with the PDN connection in order to indicate the radio bearer is inactive. In some embodiments, the method further includes the processor of the wireless device 102 receiving, from the wireless network, a TAU accept message confirming the radio bearer associated with the PDN connection is inactive. In some embodiments, the method further includes the processor of the wireless device 102 initiating a retransmission timer after the TAU request message is sent to the wireless network. In some embodiments, the method further includes the processor of the wireless device 102 preparing a second instance of the TAU request message to be sent after expiration of the retransmission timer. In some embodiments, each of multiple active PDN connections are in an idle state when the trigger to initiate the TAU procedure is detected. In some embodiments, the TAU request message includes an indication of at least one active PDN connection.

FIG. 6B illustrates a flowchart 650 of another exemplary method of NAS signaling between a processor of a wireless device 102 and a wireless network. At 652, the processor of the wireless device 102 establishes a NAS signaling connection with the wireless network to perform NAS uplink signaling with the wireless network for a procedure requested by an applications processor (AP). At 654, the processor of the wireless device 102 detects completion of the procedure for the AP. At 656, the processor of the wireless device 102 initiates a timer when no additional NAS uplink signaling via the NAS signaling connection is required. At 658, the processor of the wireless device 102, responsive to expiration of the timer, releases the NAS signaling connection locally and transitions from the connected state to the idle state.

In some embodiments, the NAS signaling connection is established to support a session management (SM) signaling procedure. In some embodiments, the NAS signaling connection is established to support a short message service (SMS) signaling procedure. In some embodiments, the NAS signaling connection is established responsive to an upper layer procedure that requests only the NAS signaling connection with the wireless network. In some embodiments, multiple active protocol data unit (PDU) sessions in an idle mode when the procedure is requested to perform the NAS uplink signaling, and the NAS signaling connection is established to request deactivation of at least one of the active PDU sessions, or in some embodiments to transmit SMS data for an SMS signaling procedure. In some embodiments, the method further includes: i) preparing a service request message to perform the procedure requested by the AP, ii) sending the service request message to the wireless network, and iii) transitioning from the idle state to the connected state with the wireless network to perform the procedure. In some embodiments, the timer comprises a standardized connection release timer.

FIG. 6C illustrates a flowchart 670 of a further exemplary method of NAS signaling between a processor of a wireless device 102 and a wireless network. At 672, the processor of the wireless device 102. At 672, the processor of the wireless device 102 sends, to a wireless network, a registration request message to establish a non-access stratum (NAS) signaling connection with the wireless network. At 674, the processor of the wireless device 102 receives, from the wireless network responsive to the registration request message, a registration reject message that includes a rejection cause indication. At 676, the processor of the wireless device 102 releases the NAS signaling connection locally after receipt of the registration reject message. At 678, the processor of the wireless device 102 triggers a cell selection search or a public land mobile network (PLMN) selection search to find a suitable cell with which to connect after release of the NAS signaling connection.

In some embodiments, the method further includes the processor of the wireless device 102: i) initiating a shortened duration connection release timer having a small non-zero value after receipt of the registration reject message, and ii) initiating release of the NAS signaling connection locally at expiration of the shortened duration connection release timer. In some embodiments, the small non-zero value of the shortened duration connection release timer reduces delay to trigger the cell selection search of the PLMN selection search. In some embodiments, the method further includes the processor of the wireless device 102: i) initiating a shortened duration connection release timer having a zero value after receipt of the registration reject message, and ii) initiating release of the NAS signaling connection locally substantially immediately after receipt of the registration reject message. In some embodiments, the rejection cause indication includes one of: i) cause #11: PLMN not allowed, ii) cause #13: roaming not allowed in tracking area, iii) cause #15: no suitable cells in tracking area, or iv) cause #35: requested service option not authorized in PLMN.

### Representative Exemplary Apparatus

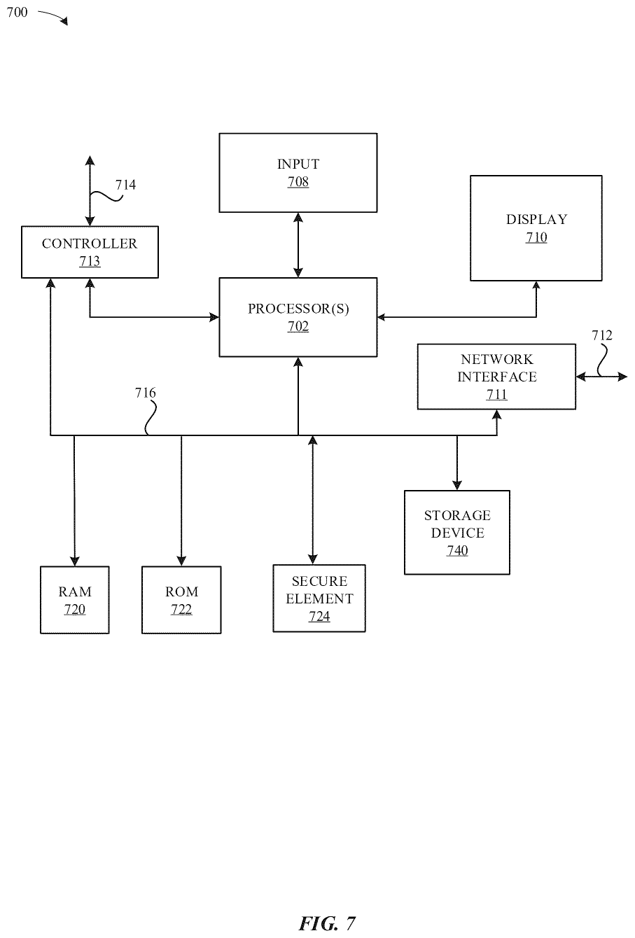

FIG. 7 illustrates in block diagram format an exemplary computing device 700 that can be used to implement the various components and techniques described herein, according to some embodiments. In particular, the detailed view of the exemplary computing device 700 illustrates various components that can be included in the wireless device 102. As shown in FIG. 7, the computing device 700 can include one or more processors 702 that represent microprocessors or controllers for controlling the overall operation of computing device 700 and/or particular functions of the computing device 700, e.g., an applications processor, a baseband processor, a power control processor, etc. In some embodiments, the computing device 700 can also include a user input device 708 that allows a user of the computing device 700 to interact with the computing device 700. For example, in some embodiments, the user input device 708 can take a variety of forms, such as a button, keypad, dial, touch screen, audio input interface, visual/image capture input interface, input in the form of sensor data, etc. In some embodiments, the computing device 700 can include a display 710 (screen display) that can be controlled by the processor(s) 702 to display information to the user (for example, information relating to incoming, outgoing, or active communication sessions). A data bus 716 can facilitate data transfer between at least a storage device 740, the processor(s) 702, and a controller 713. The controller 713 can be used to interface with and control different equipment through an equipment control bus 714. The computing device 700 can also include a network/bus interface 711 that couples to a data link 712. In the case of a wireless connection, the network/bus interface 711 can include wireless circuitry, such as a wireless transceiver and/or baseband component. The computing device 700 can also include a secure element 724. The secure element 724 can include an eUICC and/or one or more UICCs.

The computing device 700 also includes a storage device 740, which can include a single storage or a plurality of storages (e.g., hard drives and/or solid-state drives), and includes a storage management module that manages one or more partitions within the storage device 740. In some embodiments, storage device 740 can include flash memory, semiconductor (solid state) memory or the like. The computing device 700 can also include a Random-Access Memory (RAM) 720 and a Read-Only Memory (ROM) 722. The ROM 722 can store programs, utilities or processes to be executed in a non-volatile manner. The RAM 720 can provide volatile data storage, and stores instructions related to the operation of the computing device 700.

### Wireless Terminology

In accordance with various embodiments described herein, the terms “wireless communication device,” “wireless device,” “mobile device,” “mobile station,” “mobile wireless device,” and “user equipment” (UE) may be used interchangeably herein to describe one or more consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near-field communication (NFC), a cellular wireless network, a fourth generation (4G) LTE, LTE Advanced (LTE-A), 5G, and/or 6G or other present or future developed advanced cellular wireless networks.

The wireless device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless devices that are also capable of communicating via different radio access technologies (RATs). In these scenarios, a multi-mode user equipment (UE) can be configured to prefer attachment to a 5G wireless network offering faster data rate throughput, as compared to other 4G LTE legacy networks offering lower data rate throughputs. For instance, in some implementations, a multi-mode UE may be configured to fall back to a 4G LTE network or a 3G legacy network, e.g., an Evolved High Speed Packet Access (HSPA+) network or a Code Division Multiple Access (CDMA) 2000 Evolution-Data Only (EV-DO) network, when 5G wireless networks are otherwise unavailable.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method of non-access stratum signaling, the method comprising:
detecting a trigger to initiate a tracking area update (TAU) procedure;
determining that a request to disconnect a packet data network (PDN) connection with a wireless network is pending;
releasing the PDN connection locally; and
preparing a TAU request message to be sent to the wireless network, the TAU request message indicating a radio bearer associated with the PDN connection is inactive.

2. The method of claim 1, wherein the trigger to initiate the TAU procedure comprises a change in a tracking area identity (TAI) value of the wireless network based on a location of operation.

3. The method of claim 1, wherein the TAU request message does not include an identifier value for the radio bearer associated with the PDN connection in order to indicate the radio bearer is inactive.

4. The method of claim 1, further comprising:
receiving, from the wireless network, a TAU accept message confirming the radio bearer associated with the PDN connection is inactive.

5. The method of claim 1, further comprising:
initiating a retransmission timer after the TAU request message is sent to the wireless network.

6. The method of claim 5, further comprising:
preparing a second instance of the TAU request message to be sent after expiration of the retransmission timer.

7. The method of claim 1, wherein each of multiple active PDN connections are in an idle state when the trigger to initiate the TAU procedure is detected.

8. The method of claim 7, wherein the TAU request message includes an indication of at least one active PDN connection.

9. A method of non-access stratum signaling, the method comprising:
establishing a non-access stratum (NAS) signaling connection with a wireless network to perform NAS uplink signaling for a procedure requested by an applications processor (AP);
detecting completion of the procedure for the AP;
initiating a timer when no additional NAS uplink signaling via the NAS signaling connection is required; and
responsive to expiration of the timer, releasing the NAS signaling connection locally and transitioning from a connected state to an idle state.

10. The method of claim 9, wherein the NAS signaling connection is established to support a session management (SM) signaling procedure.

11. The method of claim 9, wherein the NAS signaling connection is established to support a short message service (SMS) signaling procedure.

12. The method of claim 9, wherein the NAS signaling connection is established responsive to an upper layer procedure that requests only the NAS signaling connection with the wireless network.

13. The method of claim 9, wherein:
multiple active protocol data unit (PDU) sessions are in an idle mode when the procedure is requested to perform the NAS uplink signaling; and
the NAS signaling connection is established to request deactivation of at least one of the multiple active PDU sessions.

14. The method of claim 9, further comprising:
preparing a service request message to perform the procedure requested by the AP;
sending the service request message to the wireless network; and
transitioning from the idle state to the connected state to perform the procedure.

15. The method of claim 9, wherein the timer comprises a standardized connection release timer.

16. A method of non-access stratum signaling, the method comprising:
sending, to a wireless network, a registration request message to establish a non-access stratum (NAS) signaling connection with the wireless network;
receiving, from the wireless network responsive to the registration request message, a registration reject message that comprises a rejection cause indication;
releasing the NAS signaling connection locally after receipt of the registration reject message; and
triggering a cell selection search or a public land mobile network (PLMN) selection search to find a suitable cell with which to connect after release of the NAS signaling connection.

17. The method of claim 16, further comprising:
initiating a shortened duration connection release timer having a small non-zero value after receipt of the registration reject message; and
initiating release of the NAS signaling connection locally at expiration of the shortened duration connection release timer.

18. The method of claim 17, wherein the small non-zero value of the shortened duration connection release timer reduces delay to trigger the cell selection search of the PLMN selection search.

19. The method of claim 16, further comprising:
initiating a shortened duration connection release timer having a zero value after receipt of the registration reject message; and
initiating release of the NAS signaling connection locally substantially immediately after receipt of the registration reject message.

20. The method of claim 16, wherein the rejection cause indication comprises one of:
cause #11: PLMN not allowed;
cause #13: roaming not allowed in tracking area;
cause #15: no suitable cells in tracking area; or
cause #35: requested service option not authorized in PLMN.
